(19) United States
(12) Patent Application Publication
(10) Pub. No.: US 2026/0023251 A1
(43) Pub. Date: Jan. 22, 2026

(54) OPTICAL ELEMENT, OPTICAL SYSTEM, OPTICAL EQUIPMENT, DISPLAY APPARATUS, AND IMAGING APPARATUS

(71) Applicant: CANON KABUSHIKI KAISHA, Tokyo (JP)

(72) Inventor: HIDEO GENDA, Tokyo (JP)

(21) Appl. No.: 19/249,903

(22) Filed: Jun. 25, 2025

(30) Foreign Application Priority Data
Jul. 16, 2024 (JP) 2024-113388

(51) Int. Cl. G02B 17/08

(52) U.S. Cl. CPC G02B 17/0856

(57) ABSTRACT

Provided is an optical element that includes a first base material; a first adhesive layer; a resin layer having a reflection characteristic; a second adhesive layer; and a second base material. The first base material, the first adhesive layer, the resin layer, the second adhesive layer, and the second base material are laminated in this order. When an average thickness of the first adhesive layer is T1, a Young's modulus of the first adhesive layer is E1, an average thickness of the second adhesive layer is T2, and a Young's modulus of the second adhesive layer is E2, satisfying 1.1×T1/E1≤T2/E2.

### BACKGROUND

### Technical Field

The present disclosure relates to an optical element, an optical system, optical equipment, a display apparatus, and an imaging apparatus.

### Description of the Related Art

Head-mounted displays (HMDs) have been used in various fields such as virtual reality (VR), augmented reality (AR), mixed reality (MR), and the like. The HMD has an optical system to form an image displayed on a display panel at the position aligned with a user's eye. The HMDs are desired to be compact and lightweight with high image quality and a high angle of view to enhance immersion, realism, and comfort. In order to achieve this, HMDs use a folding optical system that folds an optical path using circularly polarized light and a transmissive-reflective layer.

In recent years, folding optical systems have been applied to imaging optical systems such as camera lenses and the like in an attempt to enhance the image quality and reduce the size and weight of camera lenses.

Such a folding optical system includes a reflective polarizing layer, which is a layer that transmits light in a certain polarization direction and reflects light in a polarization direction orthogonal to said certain polarization direction. Japanese Patent Application Laid-Open No. 2021-500606 discusses an optical element in which a reflective polarizing layer is integrated with a base material. Since the reflective polarizing layer is thin and easily deformed by itself, the surface shape can be maintained by integrating the reflective polarizing layer with the base material. Japanese Patent Application Laid-Open No. 2021-500606 discusses an optical element in which a reflective polarizing layer is sandwiched between two base materials to be integrated with the two base materials. Since the reflective polarizing layers are mainly formed of resin, reflective polarizing layers are likely to change their shapes due to temperature change and water absorption. By sandwiching the reflective polarizing layer between the two base materials to be integrated with them, the shape change of the reflective polarizing layer due to temperature change and water absorption can be suppressed.

To enhance the image quality of display apparatuses and imaging apparatuses, the surface shapes of optical elements are smooth with a small shape error. In particular, when a reflective surface is formed by a reflective polarizing layer in an optical system, the reflective polarizing layer is very smooth with a small shape error. Japanese Patent Application Laid-Open No. 2023-159337 discusses an optical element in which a reflective polarizing layer is integrated with base materials by an adhesive layer having a thickness of less than 20 micrometers in order to obtain the smooth reflective polarizing with a small shape error.

In the case of an optical element in which a reflective polarizing layer is integrated between two base materials, as discussed in Japanese Patent Application Laid-Open No. 2023-159337, the optical characteristics may be greatly deteriorated due to a temperature difference when the equipment is used or when the environmental temperature of the equipment changes.

### SUMMARY

An object of the present disclosure is to provide an optical element in which the deterioration of optical characteristics due to a temperature difference can be reduced or prevented in an optical element in which a resin layer is integrated between two base materials by adhesive layers.

An aspect of the present disclosure provides an optical element that includes a first base material; a first adhesive layer; a resin layer having a reflection characteristic; a second adhesive layer; and a second base material. The first base material, the first adhesive layer, the resin layer, the second adhesive layer, and the second base material are laminated in this order, and 1.1×T1/E1≤T2/E2, with T1 being an average thickness of the first adhesive layer, E1 being a Young's modulus of the first adhesive layer, T2 being an average thickness of the second adhesive layer, and E2 being a Young's modulus of the second adhesive layer.

Another aspect of the present disclosure provides an optical element that includes a first base material; a first adhesive layer; a first resin layer having a reflection characteristic; a second adhesive layer; a second resin layer; a third adhesive layer; and a second base material. The first base material, the first adhesive layer, the first resin layer, the second adhesive layer, the second resin layer, the third adhesive layer, and the second base material are laminated in this order, and 1.1×T1/E1≤T2/E2 or 1.1×T1/E1≤T3/E3, with T1 being an average thickness of the first adhesive layer, E1 being a Young's modulus of the first adhesive layer, T2 being an average thickness of the second adhesive layer, E2 being a Young's modulus of the second adhesive layer, T3 being an average thickness of the third adhesive layer, and E3 being a Young's modulus of the third adhesive layer.

According to another aspect of the present disclosure, there is provided an optical element including: a first base material made of glass; a first adhesive layer; a resin layer having a reflection characteristic; a second adhesive layer; and a second base material made of glass, wherein the first base material, the first adhesive layer, the resin layer, the second adhesive layer, and the second base material are laminated in this order, and wherein, when an average thickness of the first adhesive layer is T1, a Young's modulus of the first adhesive layer is E1, an average thickness of the second adhesive layer is T2, and a Young's modulus of the second adhesive layer is E2, 1.1×T1/E1≤T2/E2 is satisfied.

Further features of the present disclosure will become apparent from the following description of exemplary embodiments with reference to the attached drawings.

### BRIEF DESCRIPTION OF THE DRAWINGS

FIG. 1A is a plan view illustrating an optical element according to a first embodiment of the present disclosure.

FIG. 1B is a cross-sectional view illustrating the optical element according to the first embodiment of the present disclosure.

FIG. 2A is a plan view illustrating another example of the planar shape of the optical element according to the first embodiment of the present disclosure.

FIG. 2B is a plan view illustrating another example of the planar shape of the optical element according to the first embodiment of the present disclosure.

FIG. 3 is an enlarged sectional view illustrating the optical element according to the first embodiment of the present disclosure.

FIG. 4 is an enlarged sectional view illustrating the optical element according to the first embodiment of the present disclosure.

FIG. 5 is a sectional view illustrating a display apparatus according to the first embodiment of the present disclosure.

FIG. 6 is a sectional view illustrating an imaging apparatus according to the first embodiment of the present disclosure.

FIG. 7A is a sectional view illustrating the optical element according to the first embodiment of the present disclosure.

FIG. 7B is a sectional view illustrating the optical element according to the first embodiment of the present disclosure.

FIG. 8 is a sectional view illustrating an optical element according to a comparative configuration.

FIG. 9 is a table that shows evaluation results for Examples 1 to 9 and Comparative Examples 1 and 2.

FIG. 10 is a schematic sectional view illustrating a display apparatus according to a second embodiment of the present disclosure.

FIG. 11 is a schematic sectional view illustrating an imaging apparatus according to the second embodiment of the present disclosure.

### DETAILED DESCRIPTION

### First Embodiment

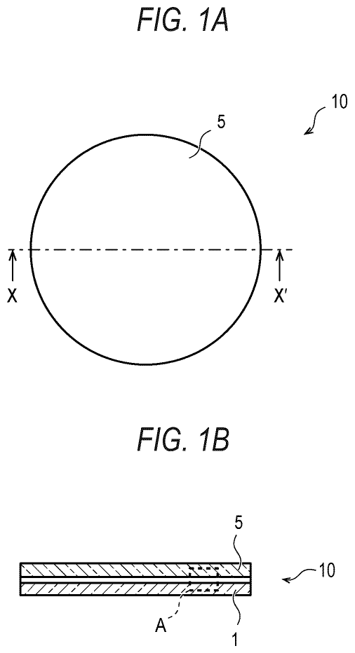

An optical element, a display apparatus and an imaging apparatus according to a first embodiment of the present disclosure will be described with reference to FIG. 1A to FIG. 7B.

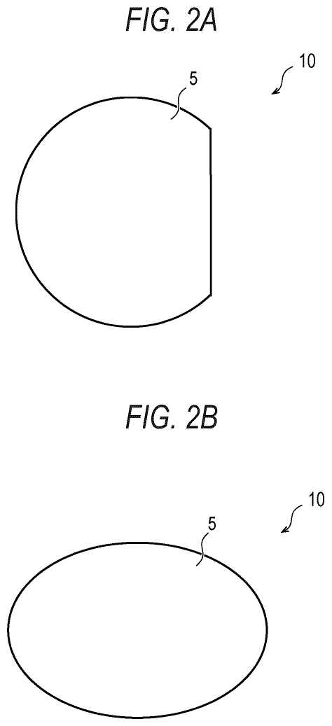

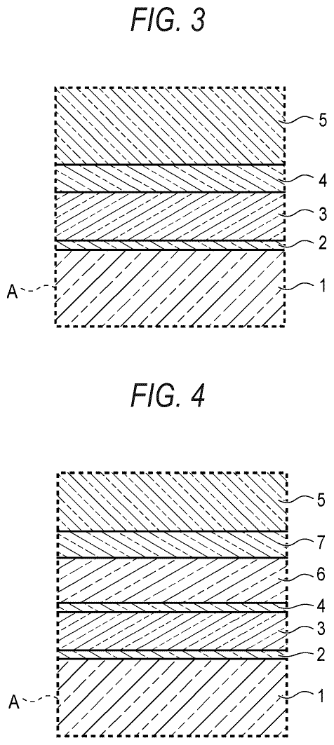

A configuration of the optical element according to the present embodiment will be described with reference to FIG. 1A to FIG. 4. FIG. 1A illustrates the shape of the optical element 10 in a plan view, when the optical element 10 is viewed in the optical axis direction. FIG. 1B is a cross-sectional view along the X-X′ line in FIG. 1A. FIG. 2A and FIG. 2B are plan views illustrating other examples of the planar shape of the optical element 10 according to the present embodiment. FIG. 3 and FIG. 4 are enlarged sectional views illustrating an enlarged area “A” illustrated by a dashed rectangle in FIG. 1B, respectively.

As illustrated in FIG. 1A, the shape of the optical element 10 according to the present embodiment in the plan view viewed in the optical axis direction is, for example, circular. The shape of the optical element 10 in the plan view may be a partial circular shape (a shape surrounded by an arc of a circle, with a chord connecting ends of the arc) as illustrated in FIG. 2A, or may be an elliptical shape, as illustrated in FIG. 2B, without being limited thereto. As for the shape of the optical element 10 in the plan view viewed in the optical axis direction, in addition to a circular shape, or the like, a shape can be selected as appropriate in consideration of downsizing, weight reduction, equipment designability, and the like.

As illustrated in FIG. 1B, the optical element 10 according to the present embodiment includes a base material 1 (first base material) that is a base member and a base material 5 (second base material) that is also a base member. The base material 1 and the base material 5 are arranged so as to face each other. FIG. 3 and FIG. 4 illustrate examples of the cross-sectional structure of the area “A” (FIG. 1B) in the optical element 10 including a layer arrangement between the base material 1 and the base material 5 arranged so as to face each other, respectively.

As illustrated in FIG. 3, the optical element 10 according to the present embodiment includes an adhesive layer 2 (first adhesive layer), a resin layer 3 and an adhesive layer 4 (second adhesive layer) laminated between the base material 1 and the base material 5, in this order, from the side of the base material 1 to the side of the base material 5, and has a structure in which the resin layer 3 is sandwiched between the base material 1 and the base material 5 via the adhesive layer 2 and the adhesive layer 4 to make the base material 1, the adhesive layer 2, the resin layer 3, the adhesive layer 4, and the base material 5 integrated with each other. In other words, the optical element 10 has an integrated structure in which the base material 1, the adhesive layer 2, the resin layer 3, the adhesive layer 4, and the base material 5 are laminated in this order to be integrated with each other. The resin layer 3 is a resin layer having an optical function as described later.

The resin layer having the optical function in the optical element 10 is not limited to the single layer of the resin layer 3. The optical element 10 may have two or more resin layers having optical functions. For example, when the resin layers having the optical function are two layers, as illustrated in FIG. 4, the optical element 10 has the adhesive layer 2, the resin layer 3, another adhesive layer 4, a resin layer 6, and a further adhesive layer 7 laminated between the base material 1 and the base material 5 in order from the side of the base material 1 to the side of the base material 5. In this case, the optical element 10 has an integrated structure in which the base material 1, the adhesive layer 2, the resin layer 3, the adhesive layer 4, the resin layer 6, the adhesive layer 7, and the base material 5 are laminated in this order to be integrated with each other. The resin layer 3 and the resin layer 6 are resin layers having optical functions, respectively.

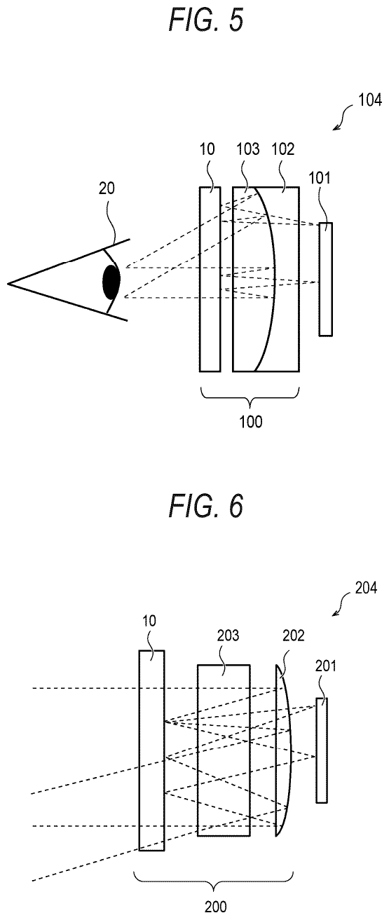

The optical element 10 according to the present embodiment is used in optical equipment such as an HMD, a digital camera, a video camera, or the like. FIG. 5 and FIG. 6 are sectional views illustrating examples of optical equipment in which the optical element 10 is used, respectively.

FIG. 5 is a sectional view illustrating an example of a display apparatus 104 such as an HMD in which the optical element 10 is used. As illustrated in FIG. 5, the display apparatus 104 includes a display optical system 100 and a display panel 101. The display optical system 100 includes the optical element 10, an optical element 102, and an optical element 103. The optical element 102, the optical element 103, and the optical element 10 are arranged with respect to the display panel 101 that displays an image on the display side thereof, positioned on the side of the eye 20 of a user who views the image. The display optical system 100 has a function of causing an image displayed on the display panel 101 to be formed on the eye 20 of the user through the optical element 102, the optical element 103, and the optical element 10. The optical element in the display optical system 100 may be provided as a single element, or as two or more elements, as long as the optical element or the optical elements satisfy the functions described herein. The dashed line in FIG. 5 indicates an optical path in a folding optical system formed by the display optical system 100, which is folded back by optical functional surfaces such as a reflective polarizing layer, a phase difference layer, a transmissive-reflective layer, and the like in the display optical system 100. Each optical functional surface is arranged on the surface of one of the optical elements or inside one of the optical elements.

FIG. 6 is a sectional view illustrating an example of an imaging apparatus 204 such as a digital camera or a video camera in which the optical element 10 is used. As illustrated in FIG. 6, the imaging apparatus 204 includes an imaging optical system 200 and an image sensor 201 that is an imaging element. The imaging optical system 200 includes the optical element 10, an optical element 203, and another optical element 202. The optical element 202, the optical element 203, and the optical element 10 are arranged between an image sensor 201, which receives light from a subject and images the subject, and the imaging side of the imaging apparatus 204 positioned on the side of the subject. The imaging optical system 200 transmits light from the subject side through the optical element 10, the optical element 203, and the optical element 202, to be imaged on the image sensor 201. The image sensor 201 receives the light from the subject, imaged through the imaging optical system 200, and generates a signal for forming an image. The optical element in the imaging optical system 200 may be provided as a single element, or as two or more, as long as the optical element or the optical elements satisfy the functions described herein. The dashed line in FIG. 6 indicates an optical path in a folding optical system formed by the imaging optical system 200, which is folded back by optical functional surfaces such as a reflective polarizing layer, a phase difference layer, a transmissive-reflective layer, and the like in the imaging optical system 200. Each optical functional surface is arranged on the surface of one of the optical elements or inside one of the optical elements.

As described above, the optical element 10 according to the present embodiment can be included in an optical system arranged between a sensor such as the image sensor 201, into which light from an object, such as a subject or the like, enters and the object. In such an optical system, the optical element 10 reflects light once by the resin layer 3 having a reflection characteristic until the light reaches the sensor.

Details of the base material 1, the base material 5, the resin layer 3, the resin layer 6, the adhesive layer 4, and the adhesive layer 7 in the optical element 10 according to the present embodiment are described herein. The optical element 10 can include an additional resin layer, which is similar to the resin layer 3 and the resin layer 6, and can include an additional adhesive layer, which is similar to the adhesive layer 4 and the adhesive layer 7.

For example, as illustrated in FIG. 1B, the base material 1 and the base material 5 each have a flat plate shape with parallel flat surfaces on both sides. The base material 1 and the base material 5 each function to maintain the shape of the optical element 10. The base material 1 and the base material 5 may be a planar shape, a convex spherical shape, a concave spherical shape, an aspherical shape, or a combination thereof. At least one of the base material 1 and the base material 5 may function as a lens, specifically, function for condensing incident light such as a convex lens, or function for diffusing incident light such as a concave lens.

The materials constituting the base material 1 and the base material 5 are not particularly limited as long as they are formed of transparent materials having transparency to light, e.g. visible light or the like, which is targeted by the optical element 10. Transparency is used to describe that the transmittance of light which is targeted by the optical element 10 is a predetermined value or more, for example, 10% or more, and the transmittance of light is in a wavelength range from 420 nm to 700 nm is 10% or more. The materials constituting the base material 1 and the base material 5 are selected from glass, resin, ceramic, and the like, for example.

The base material 1 and the base material 5 may have high bending rigidity in order to maintain the shape of the optical element 10. Therefore, the thicknesses of the base material 1 and the base material 5 may be sufficiently thicker than other resin layers or adhesive layers constituting the optical element 10. More specifically, the thicknesses of the base material 1 and the base material 5 may be 0.5 mm or more, or 1.0 mm or more, respectively. When the thickness is less than 0.5 mm, the deformation of the optical element 10 due to the force for fixing the optical element 10 to the optical equipment or due to the weight of the optical element 10 is large, which makes it difficult to maintain the shape of the optical element 10 with high accuracy.

The Young's moduli of the base material 1 and the base material 5 may be equal to or greater than the Young's moduli of other resin layers and adhesive layers that constitute the optical element 10. Specifically, the Young's moduli of the base material 1 and the base material 5 may be 0.5 GPa or more and 300 GPa or less.

The resin layer 3 and the resin layer 6 have optical functions and are selected from layers having optical functions such as a reflective polarizing layer, an absorptive polarizing layer, a phase difference layer, and a transmissive-reflective layer, and the like. The resin layer having an optical function in the optical element 10 may be provided as one layer of the resin layer 3 as illustrated in FIG. 3, two layers of the resin layer 3 and the resin layer 6 as illustrated in FIG. 4, or a plurality of layers having three or more layers. At least one layer of the resin layer 3 included in the optical element 10 has a reflection characteristic for reflecting incident light.

The reflective polarizing layer transmits light in a certain polarization direction among incident light and reflects light in a polarization direction orthogonal to said certain polarization direction. As the reflective polarizing layer, for example, a wire grid film made by Asahi Kasei Corp. (trade name “WGF®”), a laminated reflective polarizing film made by 3M Company (trade name “IQPE”), or the like can be used.

The absorptive polarizing layer transmits light in a certain polarization direction among incident light and absorbs light in a polarization direction orthogonal to said certain polarization direction. As the absorptive polarizing layer, for example, a polarizing film made by Nippon Kayaku Co., Ltd. (trade name “ACE”), a dye based polarizing film made by Nippon Kayaku Co., Ltd. (trade name “GHC”), or the like can be used.

The phase difference layer changes the polarization direction of incident light by a certain amount. As the phase difference layer, for example, a phase difference film made by Nippon Kayaku Co., Ltd. (trade name “WA-140T”), which is a polymer film, a phase difference film made by ColorLink Japan, Ltd. (trade name “CP3”) or the like can be used.

The transmissive-reflective layer separates incident light into transmitted light and reflected light at a certain ratio. As the transmissive-reflective layer, for example, a half mirror can be used.

The resin layer 3 having a reflection characteristic is not particularly limited, but the reflective polarizing layer or the transmissive-reflective layer, which is a layer having a reflection characteristic, may be among the layers having the above-mentioned optical functions. When the optical element 10 illustrated in FIG. 4 has two layers of the resin layer 3 and the resin layer 6. The resin layer 6 may be a resin layer having transmission characteristics with respect to the light targeted by the optical element 10, without being particularly limited thereto.

For example, the resin layer 3 may be the reflective polarizing layer and the resin layer 6 may be the phase difference layer. Also, for example, the resin layer 3 may be the transmissive-reflective layer and the resin layer 6 may be the phase difference layer. In these cases, the optical element 10 may be used as one element constituting the folding optical system. Further, in these cases, another resin layer functioning as the absorptive polarizing layer may be further provided between the resin layer 6 and the base material 5 via the adhesive layer. When the resin layer 3 is the reflective polarizing layer, the optical element 10 functions as a reflective polarizing optical element.

The thicknesses of the resin layer 3 and the resin layer 6 are appropriately set to thicknesses that express optical functions, respectively. However, the thicknesses of the resin layer 3 and the resin layer 6 may be thinner than the thicknesses of the base material 1 and the base material 5, so as not to greatly affect the shape of the optical element 10. Specifically, the thicknesses of the resin layer 3 and the resin layer 6 may be 10 μm or more and 300 μm or less, and may be 20 μm or more and 200 μm or less.

The Young's moduli of the resin layer 3 and the resin layer 6 may be equal to or lower than the Young's moduli of the base material 1 and the base material 5 so as not to greatly affect the shape of the optical element 10. The Young's moduli of the resin layer 3 and the resin layer 6 may be equal to or greater than the Young's moduli of the adhesive layer 2, the adhesive layer 4 and the adhesive layer 7 so as not to deform the surface shapes of the resin layer 3 and the resin layer 6, respectively. Specifically, the Young's moduli of the resin layer 3 and the resin layer 6 may be 2 MPa or more and 10 GPa or less, respectively.

The adhesive layer 2, the adhesive layer 4, and the adhesive layer 7 have a function of bonding and integrating the structures sandwiching said layers. Specifically, the adhesive layer 2 bonds and integrates the base material 1 and the resin layer 3. The adhesive layer 4 bonds and integrates the resin layer 3 and the resin layer 6. The adhesive layer 7 bonds and integrates the resin layer 6 and the base material 5.

The materials constituting the adhesive layer 2, the adhesive layer 4 and the adhesive layer 7 are not particularly limited as long as they are transparent to light such, as visible light or the like, which is targeted by the optical element 10. However, the materials constituting the adhesive layer 2, the adhesive layer 4 and the adhesive layer 7 may be light-curable resins or thermosetting resins from the viewpoint of ease of manufacture.

The thicknesses of the adhesive layer 2, the adhesive layer 4 and the adhesive layer 7 are suitably set in the configuration of the optical element 10 according to the performance, size, shape and the like of the optical element 10. Specifically, the thicknesses of the adhesive layer 2, the adhesive layer 4 and the adhesive layer 7 may be from 1 μm or more and 100 μm or less, and may be from 3 μm or more and 50 μm or less, respectively.

The Young's moduli of the adhesive layer 2, the adhesive layer 4 and the adhesive layer 7 may be equal to or lower than the Young's moduli of the base material 1 and the base material 5 so as not to greatly affect the shape of the optical element 10. The Young's moduli of the adhesive layer 2, the adhesive layer 4 and the adhesive layer 7 may be equal to or lower than the Young's modulus of the resin layer 3 so as not to deform the surface shape of at least the resin layer 3 having a reflection characteristic among the resin layer 3 and the resin layer 6. Specifically, the Young's moduli of the adhesive layer 2, the adhesive layer 4 and the adhesive layer 7 may be 0.01 MPa or more and 3 GPa or less, respectively.

The thickness of the adhesive layer 2, the adhesive layer 4 and the adhesive layer 7 can be measured by cutting the optical element 10 and measuring its cross-sectional shape, for example, using an image measuring machine (product name “NEXIV®”) manufactured by Nikon Corporation. The thickness can be calculated as an average thickness which is an average value of measured values at a plurality of positions in the optical element 10. The Young's moduli of the adhesive layer 2, the adhesive layer 4 and the adhesive layer 7 can be measured by peeling the surface of the adhesive layer in the optical element 10 and using, for example, a nanoindenter (product name “NanoIndenter G-200”) manufactured by Agilent Technologies Japan, Ltd. The Young's modulus can be calculated as an average Young's modulus which is an average value of measured values at a plurality of positions of the adhesive layer in the optical element 10.

Transparent inorganic films may be provided on the surfaces of the base material 1 and the base material 5. The transparent inorganic films may also be provided between the base material 1 and the adhesive layer 2, between the adhesive layer 2 and the resin layer 3, between the resin layer 3 and the adhesive layer 4, between the adhesive layer 4 and the base material 5, between the adhesive layer 4 and the resin layer 6, between the resin layer 6 and the adhesive layer 7, and between the adhesive layer 7 and the base material 5. The transparent inorganic film may be provided on all of these surfaces and the interlayers, or may be provided on any of these surfaces and interlayers. For example, the transparent inorganic film may be provided on the upper surface of the base material 1, which is the surface of the side of the base material 5, and the adhesive layer 2 and the resin layer 3 may be sequentially provided on the base material 1 via the transparent inorganic film. In this case, the transparent inorganic film is a thin film made of a transparent inorganic material having transparency to light such as visible light or the like targeted by the optical element 10.

Examples of the inorganic material of the transparent inorganic film include aluminum oxide (Al₂O₃), silicon oxide (SiO₂, SiO), titanium oxide (TiOₓ), tantalum oxide (TaOₓ), niobium oxide (NbOₓ), and the like. The transparent inorganic film can be formed by various deposition methods such as vacuum deposition, sputtering, and the like. With the transparent inorganic film provided, the adhesion force between the respective layers can be improved and the reflection due to the difference in refractive index of the interface can be suppressed. The thickness of the transparent inorganic film is suitably set according to its function, but specifically, thickness of the transparent inorganic film is, for example, 10 nm or more and 1000 nm or less.

Here, the average thickness of the adhesive layer 2 is T1, the Young's modulus of the adhesive layer 2 is E1, the average thickness of the adhesive layer 4 is T2, and the Young's modulus of the adhesive layer 4 is E2. In the configuration illustrated in FIG. 3, the optical element 10 according to the present embodiment is configured to satisfy Equation (1-1) and Equation (1-2):

$$1.1 \times T 1 / E 1 \leq T 2 / E 2 \qquad ( 1 - 1 )$$

$$1.8 \times T 1 / E 1 \leq T 2 / E 2 \qquad ( 1 - 2 )$$

In general, when the thickness of the adhesive layer is T and the Young's modulus of the adhesive layer is E, the value T/E obtained by dividing the thickness T by the Young's modulus E is empirically an index that indicates the local deformability of the adhesive layer. The thickness of the adhesive layer is set to about 1 μm or more and 100 μm or less, and has a very small bending rigidity with respect to the base material. Therefore, the adhesive layer has a small influence on the deformation of the entire optical element such as warpage, for example. On the other hand, when a local compressive or tensile force is applied to the adhesive layer, the adhesive layer itself is locally compressively or extensively deformed. In this case, when the thickness of the adhesive layer is, for example, twice a reference, the adhesive layer is deformed about twice the reference, and when the Young's modulus of the adhesive layer is, for example, twice a reference, the adhesive layer is deformed about ½ of the reference. That is, the greater the value T/E obtained by dividing the thickness T of the adhesive layer by the Young's modulus E, the greater the amount of deformation when the same force is applied. Equations (1-1) and (1-2) mean that the index of the deformability of the adhesive layer 4 is 1.1 times or more, or 1.8 times or more, than the index of the deformability of the adhesive layer 2, and the adhesive layer 2 is relatively hard to deform and the adhesive layer 4 is relatively easy to deform.

In the case of a conventional optical element such as discussed in Japanese Patent Application Laid-Open No. 2023-159337, in which a reflective polarizing layer is sandwiched between two base materials to be integrated with the base materials, the optical characteristics of the optical element are greatly deteriorated when the equipment is used or the ambient temperature of the equipment is changed, and the image quality is greatly deteriorated in the equipment such as a display apparatus and an imaging apparatus. This is caused by a temperature difference between the two base materials of the integrated optical element. For example, when using an HMD, heat from the display panel, other electronic components, and the person wearing the HND is transmitted to the optical element. Also, when the ambient temperature changes, such as when the equipment is taken out of the room, a temperature difference occurs as the temperature of the equipment gets used to the ambient temperature. Then, a difference occurs in the expansion amount of the two base materials due to the temperature difference, the end of the base material with the larger expansion amount warps toward the base material with the smaller expansion amount, and the surface shape of the optical element, especially the surface shape of the reflective polarizing layer, changes by the warpage. As a result, the optical characteristics of the optical element deteriorate due to the change in the surface shape of the optical element, and the image quality deteriorates in the equipment such as a display apparatus, an imaging apparatus, or the like.

When the equipment in which the optical element 10 is used or when the ambient temperature of the equipment changes, as described above, a temperature difference occurs in the optical element 10, and deformation such as warpage occurs in the optical element 10 due to a difference in the expansion amount between the base material 1 and the base material 5. As a result, the optical performance might deteriorate. The resin layer 3 is a layer having an optical function that should not be deformed, in order not to deteriorate the optical performance of the optical element 10. In particular, since the resin layer 3 has a reflection characteristic, it is extremely important not to deform the resin layer 3 in order to reduce or prevent deterioration of optical performance.

In the configuration illustrated in FIG. 3, the resin layer 3 is adhered and fixed to the surface of the base material 1 via the adhesive layer 2. The adhesive layer 2 is relatively less likely to deform compared with the adhesive layer 4. Therefore, the resin layer 3 can be accurately follow the surface shape of the base material 1. On the other hand, although the resin layer 3 is adhered and fixed to the surface of the base material 5 via the adhesive layer 4, the adhesive layer 4 is relatively easily deformed compared with the adhesive layer 2. Therefore, the adhesive layer 4 can be flexibly deformed with respect to the surface shape of the base material 5.

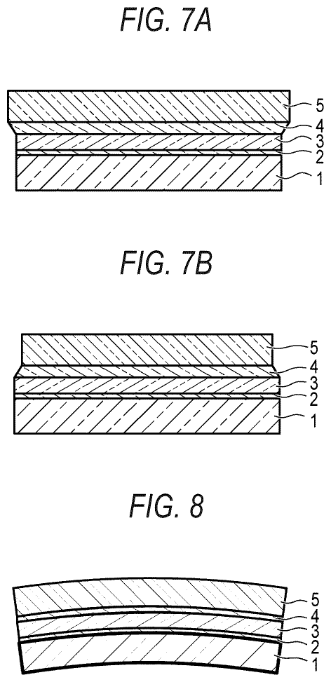

In the optical element 10 according to the present embodiment, since the adhesive layer 4 is relatively easily deformed as compared with the adhesive layer 2, the deformation of the resin layer 3 can be suppressed or prevented even when a temperature difference occurs. The mechanism by which the deformation of the resin layer 3 is suppressed or prevented in the optical element 10 according to the present embodiment will be described with reference to FIG. 7A to FIG. 8. FIG. 7A is a cross-sectional view illustrating a deformation of the optical element 10 when the diameter of the base material 5 becomes relatively larger than the diameter of the base material 1 due to a temperature difference in the optical element 10 according to the present embodiment. FIG. 7B is a cross-sectional view illustrating a deformation of the optical element 10 when the diameter of the base material 5 becomes relatively small relative to the diameter of the base material 1 due to a temperature difference in the optical element 10 according to the present embodiment. FIG. 8 is a cross-sectional view illustrating a deformation of the optical element 10 when, hypothetically, the adhesive layer 4 is hardly deformed in the same manner as the adhesive layer 2. FIG. 7A to FIG. 8 correspond to the cross-sectional views illustrated in FIG. 1B and FIG. 3.

For example, when the diameter of the base material 5 increases relative to the diameter of the base material 1 due to a temperature difference, the resin layer 3 follows the surface shape of the base material 1 via the adhesive layer 2, which is relatively hard to deform. On the other hand, the resin layer 3 is adhered and fixed to the base material 5 via the adhesive layer 4, which is relatively easy to deform. Therefore, as illustrated in FIG. 7A, the adhesive layer 4 is deformed to match the shape difference between the resin layer 3 and the base material 5, thereby reducing or preventing the deformation of the resin layer 3 such as warpage or the like. Similarly, when the diameter of the base material 5 becomes smaller relative to the diameter of the base material 1, as illustrated in FIG. 7B, the adhesive layer 4 is deformed to match the shape difference between the resin layer 3 and the base material 5, thereby reducing or preventing the deformation of the resin layer 3 such as warpage or the like.

As described above, according to the present embodiment, the deformation of the resin layer 3 having a reflection characteristic can be reduced or prevented when the equipment is used or the environmental temperature changes, and the deterioration of the optical characteristic of the optical element 10 can be reduced or prevented.

From the viewpoint of sufficiently reducing or preventing the deformation of the resin layer 3, the average thickness T1 of the adhesive layer 2 may be set in the range of 3 μm or more and 20 μm or less, and the Young's modulus E1 of the adhesive layer 2 may be set in the range of 1 MPa or more and 100 MPa or less. From the same viewpoint, the average thickness T2 of the adhesive layer 4 may be set in the range of 3 μm or more and 100 μm or less, and the Young's modulus E2 of the adhesive layer 4 may be set in the range of 0.1 MPa or more and 100 MPa or less.

If the adhesive layer 4 is not easily deformed in the same manner as the adhesive layer 2, as illustrated in FIG. 8, the adhesive layer 2 and the adhesive layer 4 cannot be deformed locally, and the base material 1 and the base material 5 are deformed by warpage or the like, thereby deforming the resin layer 3. As a result, it is difficult to reduce or prevent the deterioration of the optical characteristics of the optical element 10.

As described above, the optical element 10 may have a structure in which the base material 1, the adhesive layer 2, the resin layer 3, the adhesive layer 4, the resin layer 6, the adhesive layer 7 and the base material 5 are laminated in this order and integrated, which is illustrated in FIG. 4. In this case, the adhesive layer 7 can be configured in the same manner as the adhesive layer 4. Here, the average thickness of the adhesive layer 7 is T3, and the Young's modulus of the adhesive layer 7 is E3. When the optical element 10 has the configuration illustrated in FIG. 4, the optical element 10 may be configured to satisfy Equation (2-1) or Equation (3-1), and may be configured to satisfy Equation (2-2) or Equation (3-2):

$$1.1 \times T 1 / E 1 \leq T 2 / E 2 \qquad ( 2 - 1 )$$

$$1.8 \times T 1 / E 1 \leq T 2 / E 2 \qquad ( 2 - 2 )$$

$$1.1 \times T 1 / E 1 \leq T 3 / E 3 \qquad ( 3 - 1 )$$

$$1.8 \times T 1 / E 1 \leq T 3 / E 3 \qquad ( 3 - 2 )$$

When the above relation is satisfied, the adhesive layer 2 is hardly deformed sufficiently with respect to the adhesive layer 4 or the adhesive layer 7, so that the resin layer 3 can accurately follow the surface shape of the base material 1. Since the adhesive layer 4 or the adhesive layer 7 is easily deformed sufficiently with respect to the adhesive layer 2, the adhesive layer 4 or the adhesive layer 7 deforms so as to match the shape difference between the resin layer 3 and the base material 5, thereby reducing or preventing deformation such as warpage of the resin layer 3. The resin layer 6 can also be deformed to match the shape difference between the resin layer 3 and the base material 5. When the resin layer 6 is a transmission layer having no reflection characteristic, the deformation of the resin layer 6 does not have a large effect on the optical characteristics of the optical element 10. The deformation of the resin layer 6 can reduce or prevent the deformation of the resin layer 3, such as warpage or the like. Thus, even when the optical element 10 has the configuration illustrated in FIG. 4, the deformation of the resin layer 3 having a reflection characteristic can be reduced or prevented, and the deterioration of the optical characteristic of the optical element 10 can be reduced or prevented.

In the optical element 10 according to the present embodiment, since the resin layer 3 is a layer having a reflection characteristic such as a reflective polarizing layer, a transmissive-reflective layer, or the like, deterioration of the optical characteristic is reduced or prevented.

In optical equipment, light passes through an optical element and passes through or reflects at an interface having different refractive indices to form an image on the eye of an observer, an image sensor, or the like. If there is a shape error in the surface shape of the interface, an optical path difference occurs, and the optical characteristics of the optical element 10 deteriorate. Here, when the interface is a transmissive surface, the optical characteristics deteriorate in proportion to the refractive index difference between the two layers constituting the interface. When the interface is a reflective surface, the optical characteristics deteriorate in proportion to twice the difference between the refractive index of the layer on the reflection side and the vacuum refractive index.

When considering the interface between the resin layer and the adhesive layer as used in the optical element 10 according to the present embodiment, for example, the refractive index of the resin layer is 1.54 and the refractive index of the adhesive layer is 1.50. Then, the influence of the shape error of the interface between the resin layer and the adhesive layer on the optical characteristics is approximately 25 times greater in the case of the reflective surface than in the case of the transmissive surface, as shown in Equation (4):

$$( 1.5 - 1. ) \times 2 / ( 1.54 - 1.5 ) = 25 \qquad ( 4 )$$

Therefore, when the resin layer 3 is a layer having a reflection characteristic such as a reflective polarizing layer, a transmissive-reflective layer, or the like, the influence of the deformation of the resin layer 3 on the optical characteristics is very large, and the effect of reducing or preventing the deterioration of the optical characteristics of the optical element 10 by reducing or preventing the deformation of the resin layer 3 is greater.

The average thickness of the adhesive layer 2 may be 20 μm or less from the viewpoint of sufficiently obtaining the effect of reducing or preventing the deterioration of the optical characteristics of the optical element 10. Since the adhesive layer 2 is sufficiently thin in this manner, the resin layer 3 can more accurately follow the surface shape of the base material 1. Since the adhesive layer 2 is sufficiently thin, deformation due to temperature change of the adhesive layer 2 itself is small, and deformation of the resin layer 3 can be sufficiently reduced or prevented.

Although the base material 1 and the base material 5 may be made of materials having the same or different linear expansion coefficients from each other, when the base material 1 and the base material 5 are made of materials having different linear expansion coefficients from each other, deterioration of the optical characteristics of the optical element 10 is reduced or prevented. When the base material 1 and the base material 5 are made of materials having the same linear expansion coefficients, a temperature difference between the base material 1 and the base material 5 causes a difference in the amount of expansion between them, resulting in deformation such as warpage or the like in the optical element 10. On the other hand, when the base material 1 and the base material 5 are made of materials having the same linear expansion coefficients, no difference in expansion is generated when the temperature rises or falls if there is no temperature difference, and deformation such as warpage or the like does not occur in the optical element 10. However, when the base material 1 and the base material 5 are made of materials having different linear expansion coefficients from each other, a difference in the expansion amount occurs even if there is no temperature difference when the temperature rises or falls, and deformation such as warpage or the like occurs in the optical element 10. Even when such deformation occurs, according to the present embodiment, the deterioration of the optical characteristics of the optical element 10 can be reduced or prevented by reducing or preventing the deformation of the resin layer 3.

Although the method of manufacturing the optical element 10 according to the present embodiment is not particularly limited, the optical element 10 can be manufactured independently or in combination with, for example, a film laminating technique, a bonding technique, a resin layer molding technique, an insert molding technique, or the like. As an example, a case of manufacturing the optical element 10 illustrated in FIG. 3 by using a method of manufacturing the optical element 10 combining a film laminating technique and a bonding technique is described below.

Initially, the base material 1, the base material 5, a resin film to be the resin layer 3, and adhesives to be the adhesive layer 2 and the adhesive layer 4 are prepared. The adhesives may be a light-curing type adhesive, a heat-curing type adhesive, a two-liquid mixed type adhesive, a gluing agent, and the like. A light-curing type adhesive may suitably be used due to the ease of manufacturing. The adhesive to be the adhesive layer 2 and the adhesive to be the adhesive layer 4 may be the same or different from each other.

The liquid adhesive to be the adhesive layer 2 is then discharged onto the base material 1 using a precision dispenser. Next, the resin film to be the resin layer 3 is brought into contact with the adhesive, and the adhesive sandwiched between the base material 1 and the resin film is thinly pressed and spread. The pressing and spreading of the adhesive may be performed, for example, by squeezing using a spatula or roller, pressurizing by pressing a support member against the back surface of the film, or pressurizing using compressed gas or atmospheric pressure difference by depressurization. Here, the adhesive may be attached to the base material 1 using a sheet-like material instead of a liquid one. Thereafter, the adhesive is cured by ultraviolet irradiation, heating, or the like to obtain an intermediate element in which the base material 1 and the resin film are laminated via the adhesive and integrated.

Next, the liquid adhesive to be the adhesive layer 4 is discharged on the surface of the intermediate element on the side of the resin film. Another base material 5 is then brought into contact with the adhesive and the adhesive is thinly pressed and spread. The pressing and spreading of the adhesive may be performed by a method similar to the above. Thereafter, the adhesive is cured by ultraviolet irradiation, heating, or the like, and a base material 5 is provided on the surface of the intermediate element on the side of the resin film. Thus, the optical element 10 in which the base material 1, the adhesive layer 2, the resin layer 3, the adhesive layer 4, and the base material 5 are laminated and integrated can be manufactured.

In contrast to the case of manufacturing from the side of the base material 1, the intermediate element in which the base material 5 and the resin film are laminated via an adhesive and integrated can be obtained, and the optical element 10 can be manufactured from the base material 5 side by providing the base material 1 via the adhesive on the surface of the intermediate element on the side of the resin film.

The optical element 10 according to the first embodiment is described with reference to the following examples.

### Example 1

The optical element 10 and the method of manufacturing the optical element 10 according to Example 1 will be described. In Example 1, the optical element 10 having the shape illustrated in FIG. 1A, FIG. 1B and FIG. 4 was manufactured.

In Example 1, a glass plate (product name “S-BSL7”, manufactured by Ohara Inc.) was prepared as the base material 1. The base material 1 had an outer diameter φ of 46 mm, a thickness of 2.0 mm, and a flat plate shape with parallel optical mirror surfaces on opposite sides. Next, a glass plate (product name “S-BSL7”, manufactured by Ohara Inc.) was prepared as the base material 5. The base material 5 had an outer diameter φ of 50 mm, a thickness of 2.0 mm, and a flat plate shape with parallel optical mirror surfaces on opposite sides. Next, an ultraviolet-curable adhesive (product name “OP-1055H”, manufactured by Kyoritsu Chemical & Co., Ltd.) to be the adhesive layer 2 was prepared. When the adhesive was cured, the Young's modulus of the adhesive layer was 9.3 MPa. Next, an ultraviolet-curable adhesive (product name “WR-3970”, manufactured by Kyoritsu Chemical & Co., Ltd.) to be the adhesive layer 4 and the adhesive layer 7 was prepared. When the adhesive was cured, the Young's modulus of the adhesive layer was 0.2 MPa. Next, a laminated reflective polarizing film (product name “IQPE”, manufactured by 3M Company) was prepared as a resin film to be the resin layer 3. The resin film had an outer diameter φ of 46 mm and a thickness of 60 μm. Next, a phase difference film (trade name “CP3”, manufactured by ColorLink Japan, Ltd.) was prepared as a resin film to be the resin layer 6. The resin film had an outer diameter φ of 46 mm and a thickness of 200 μm.

Next, 20 μl of the adhesive to be the adhesive layer 2 was discharged on the base material 1 using a precision dispenser. Next, the resin film to be the resin layer 3 was brought into contact with the adhesive from the top, and a flat plate glass for pressurization weighing 3 kg was placed on the top and allowed to rest for 180 seconds. Thereafter, the flat plate glass for pressurization was removed, and the adhesive was cured by irradiating the resin film with ultraviolet rays having a wavelength of 365 nm at a strength of 10 mW/cm² for 300 seconds to obtain the first intermediate element.

Next, 20 μl of the adhesive to be the adhesive layer 4 was discharged on the surface of the first intermediate element on the side of the resin film using the precision dispenser. Next, the resin film to be the resin layer 6 was brought into contact with the adhesive from the top, and a flat plate glass for pressurization weighing 3 kg was placed on the top and allowed to rest for 180 seconds. Thereafter, the flat plate glass for pressurization was removed, and the adhesive was cured by irradiating the resin film with ultraviolet rays having a wavelength of 365 nm at a strength of 10 mW/cm² for 300 seconds to obtain the second intermediate element.

Next, 100 μl of the adhesive to be the adhesive layer 7 was discharged on the surface of the second intermediate element on the side of the resin film using the precision dispenser. Next, the base material 5 was brought into contact with the adhesive from the top, and a flat plate glass for pressurization weighing 200 g was placed on the top and allowed to rest for 60 seconds. Thereafter, the flat plate glass for pressurization was removed, and the adhesive was cured by irradiating the adhesive from the top of the base material 5 with ultraviolet rays having a wavelength of 365 nm at a strength of 10 mW/cm² for 300 seconds to obtain the optical element 10 according to Example 1.

The optical element 10 according to Example 1 manufactured as described above was evaluated by measuring the change in the reflected wavefront in response to the change in the environmental temperature. The optical element 10 was evaluated by measuring the change in the reflected wavefront in response to the change in the environmental temperature, to determine whether the change in the reflected wavefront of the optical element 10 greatly affects the optical characteristics of the optical equipment. In the evaluation of the optical element 10, the optical element 10 was installed in a housing simulating optical equipment. Then, after the optical element 10 was left in an environment of 20° C. for more than three hours, the reflected wavefront was measured using an interferometer with a product “Verifire AT” manufactured by ZYGO Corporation. This measured result was taken as a reference reflected wavefront in a state in which the optical element 10 is at room temperature with no temperature difference. Next, the optical element 10 installed in the housing was left in an environment of minus 10° C. for three hours. Then, the optical element 10 was left in an environment of 20° C. for ten minutes, and the reflected wavefront was measured. The difference between this measured result and the reference reflected wavefront was analyzed, and the difference was defined as a reflected wavefront change in the optical element 10.

Regarding evaluations of the optical element, when the reflected wavefront change was less than 100 nm, the optical characteristics were not greatly affected, and therefore, the optical element 10 was evaluated as “A”, which is excellent. When the reflected wavefront change was 100 nm or more and less than 200 nm, there was no problem in the optical performance, and therefore, the optical element 10 was evaluated as “B”, which is good. When the reflected wavefront change is 200 nm or more, the deterioration of the optical characteristics cannot be ignored, and therefore, the optical element 10 was evaluated as “C”, which is bad.

When the optical element 10 according to Example 1 was evaluated by the above evaluation method, the reflected wavefront change was 40 nm, and therefore, the optical element 10 according to Example 1 was evaluated as “A”.

Next, the average thicknesses of the adhesive layer 2, the adhesive layer 4, and the adhesive layer 7 were measured for the optical element 10 according to Example 1. Initially, the optical element 10 was cut with a diamond wire saw so as to make a cross section illustrated in FIG. 1B appear. Next, the cut cross section was polished. Thereafter, the cross-sectional shape was observed using an image measuring machine “NEXIV®” manufactured by Nikon Corporation, and the thickness of the adhesive layer 2, the adhesive layer 4 and the adhesive layer 7 were measured, respectively. The average thicknesses of the adhesive layer 2, the adhesive layer 4, and the adhesive layer 7 were calculated from the average of the thicknesses at a total of five locations: one location in the center, two locations 10 mm from the center to the outside, and two locations 20 mm from the center to the outside in the cross section of the adhesive layers, respectively. As a result, in the optical element 10 according to Example 1, the average thickness of the adhesive layer 2 was 6 μm, the average thickness of the adhesive layer 4 was 6 μm, and the average thickness of the adhesive layer 7 was 30 μm.

### Example 2

In Example 2, an ultraviolet-curable adhesive (trade name “OP-1055H”, manufactured by Kyoritsu Chemical Industry Co., Ltd.) was used as the adhesive to be the adhesive layer 4 and the adhesive layer 7. In the step of forming the adhesive layer 7, 40 μl of the adhesive to be the adhesive layer 7 was discharged on the surface of the second intermediate element on the side of the resin film using the precision dispenser. Next, the base material 5 was brought into contact with the adhesive from the top, and a flat plate glass for pressurization weighing 3 kg was placed on the top and allowed to rest for 60 seconds. The optical element 10 according to Example 2 was manufactured in the same manner as in Example 1 except for these points.

The optical element 10 according to Example 2 was evaluated as “A” since the reflected wavefront change was 70 nm when the reflected wavefront change with respect to the environmental temperature change was measured in the same manner as Example 1.

The average thicknesses of the adhesive layer 2, the adhesive layer 4, and the adhesive layer 7 were measured as in Example 1 for the optical element 10 according to Example 2. As a result, in the optical element 10 according to Example 2, the average thickness of the adhesive layer 2 was 6 μm, the average thickness of the adhesive layer 4 was 6 μm, and the average thickness of the adhesive layer 7 was 11 μm.

### Example 3

In Example 3, in the step of forming the adhesive layer 2, 50 μl of the adhesive to be the adhesive layer 2 was discharged onto the base material 1 using the precision dispenser. Next, the resin film to be the resin layer 3 was brought into contact with the adhesive from the top, and a flat plate glass for pressurization weighing 200 g was placed on the top and allowed to rest for 180 seconds. In the step of forming the adhesive layer 7, 100 μl of the adhesive to be the adhesive layer 7 was discharged on the surface of the second intermediate element on the side of the resin film using the precision dispenser. Next, the base material 5 was brought into contact with the adhesive from the top, and a parallel plate glass for pressurization weighing 200 g was placed on the top and allowed to rest for 60 seconds. The optical element 10 according to Example 3 was manufactured in the same manner as Example 2 except for these points.

The optical element 10 according to Example 3 was evaluated as “A” since the reflected wavefront change was 80 nm when the reflected wavefront change with respect to the environmental temperature change was measured in the same manner as Example 1.

The average thicknesses of the adhesive layer 2, the adhesive layer 4 and the adhesive layer 7 were measured in the same manner as Example 1 for the optical element 10 according to Example 3. As a result, in the optical element 10 according to Example 3, the average thickness of the adhesive layer 2 was 18 μm, the average thickness of the adhesive layer 4 was 6 μm, and the average thickness of the adhesive layer 7 was 32 μm.

### Example 4

In Example 4, an ultraviolet-curable adhesive (trade name “OP-1903R”, manufactured by Kyoritsu Chemical Industry Co., Ltd.) was used as the adhesive to be the adhesive layer 4 and the adhesive layer 7. When the adhesive was cured, the Young's modulus of the adhesive layer was 0.4 MPa. In the step of forming the adhesive layer 7, 20 μl of the adhesive to be the adhesive layer 7 was discharged on the surface of the second intermediate element on the side of the resin film using the precision dispenser. Next, the base material 5 was brought into contact with the adhesive from the top, and a flat plate glass for pressurization weighing 3 kg was placed on the top and allowed to rest for 180 seconds. The optical element 10 according to Example 4 was manufactured in the same manner as in Example 2 except for these points.

The optical element 10 according to Example 4 was evaluated as “A” since the reflected wavefront change was 70 nm when the reflected wavefront change with respect to the environmental temperature change was measured in the same manner as in Example 1.

The average thicknesses of the adhesive layer 2, the adhesive layer 4, and the adhesive layer 7 were measured in the same manner as in Example 1 for the optical element 10 according to Example 4. As a result, in the optical element 10 according to Example 4, the average thickness of the adhesive layer 2 was 6 μm, the average thickness of the adhesive layer 4 was 6 μm, and the average thickness of the adhesive layer 7 was 6 μm.

### Example 5

In Example 5, in the step of forming the adhesive layer 2, 100 μl of the adhesive to be the adhesive layer 2 was discharged onto the base material 1 using the precision dispenser. Next, the resin film to be the resin layer 3 was brought into contact with the adhesive from the top, and a flat plate glass for pressurization weighing 200 g was placed on the top and allowed to rest for 60 seconds. In the step of forming the adhesive layer 7, 200 μl of the adhesive to be the adhesive layer 7 was discharged on the surface of the second intermediate element on the side of the resin film side using the precision dispenser. Next, the base material 5 was brought into contact with the adhesive from the top, and a parallel plate glass for pressurization weighing 200 g was placed on the top and allowed to rest for 10 seconds. The optical element 10 according to Example 5 was manufactured in the same manner as in Example 2 except for these points.

The optical element 10 according to Example 5 was evaluated as “B” since the reflected wavefront change was 130 nm when the reflected wavefront change with respect to the environmental temperature change was measured in the same manner as in Example 1.

The average thicknesses of the adhesive layer 2, the adhesive layer 4, and the adhesive layer 7 were measured in the same manner as in Example 1 for the optical element 10 according to Example 5. As a result, in the optical element 10 according to Example 5, the average thickness of the adhesive layer 2 was 30 μm, the average thickness of the adhesive layer 4 was 6 μm, and the average thickness of the adhesive layer 7 was 60 μm.

### Example 6

In Example 6, the optical element 10 was manufactured without forming the resin layer 6 and the adhesive layer 7. In the step of forming the adhesive layer 4, 100 μl of the adhesive to be the adhesive layer 4 was discharged on the surface of the first intermediate element on the side of the resin film using the precision dispenser. Next, the base material 5 was brought into contact with the adhesive from the top, and a parallel plate glass for pressurization weighing 200 g was placed on the top and allowed to rest for 60 seconds. The optical element 10 according to Example 6 was manufactured in the same manner as in Example 1 except for these points.

The optical element 10 according to Example 6 was evaluated as “A” since the reflected wavefront change was 70 nm when the reflected wavefront change with respect to the environmental temperature change was measured in the same manner as in Example 1.

The average thicknesses of the adhesive layer 2 and the adhesive layer 4 were measured in the same manner as in Example 1 for the optical element 10 according to Example 6. As a result, in the optical element 10 according to Example 6, the average thickness of the adhesive layer 2 was 6 μm and the average thickness of the adhesive layer 4 was 30 μm.

### Example 7

In Example 7, the optical element 10 was manufactured without forming the resin layer 6 and the adhesive layer 7. In the step of forming the adhesive layer 2, 50 μl of the adhesive to be the adhesive layer 2 was discharged on the base material 1 using the precision dispenser. Next, the resin film to be the resin layer 3 was brought into contact with the adhesive from the top, and a flat plate glass for pressurization weighing 200 g was placed on the top and allowed to rest for 180 seconds. In the step of forming the adhesive layer 4, 100 μl of the adhesive to be the adhesive layer 4 was discharged on the surface of the first intermediate element on the resin film side using a precision dispenser. Next, the base material 5 was brought into contact with the adhesive from the top, and a parallel plate glass for pressurization weighing 200 g was placed on the top and allowed to rest for 60 seconds. The optical element 10 according to Example 7 was manufactured in the same manner as in Example 2 except for these points.

The optical element 10 according to Example 7 was evaluated as “A” since the reflected wavefront change was 90 nm when the reflected wavefront change with respect to the environmental temperature change was measured as in Example 1.

The average thicknesses of the adhesive layer 2 and the adhesive layer 4 were measured as in Example 1 for the optical element 10 according to Example 7. As a result, the average thickness of the adhesive layer 2 was 18 μm and the average thickness of the adhesive layer 4 was 32 μm in the optical element 10 according to Example 7.

### Example 8

In Example 8, the optical element 10 was manufactured without forming the resin layer 6 and the adhesive layer 7. An ultraviolet-curable adhesive (trade name “OP-1903R”, manufactured by Kyoritsu Chemical Industry Co., Ltd.) was used as the adhesive to be the adhesive layer 4. In the step of forming the adhesive layer 4, 20 μl of the adhesive to be the adhesive layer 4 was discharged on the surface of the first intermediate element on the side of the resin film using the precision dispenser. Next, the base material 5 was brought into contact with the adhesive from the top, and a flat plate glass for pressurization weighing 3 kg was placed on the top and allowed to rest for 180 seconds. The optical element 10 according to Example 8 was manufactured in the same manner as Example 6 except for these points.

The optical element 10 according to Example 8 was evaluated as “A” since the reflected wavefront change was 90 nm when the reflected wavefront change with respect to the environmental temperature change was measured in the same manner as Example 1.

The average thicknesses of the adhesive layer 2 and the adhesive layer 4 were measured in the optical element 10 according to Example 8 in the same manner as Example 1. As a result, the average thickness of the adhesive layer 2 was 6 μm and the average thickness of the adhesive layer 4 was 6 μm in the optical element 10 according to Example 8.

### Example 9

In Example 9, the optical element 10 was manufactured without forming the resin layer 6 and the adhesive layer 7. In the step of forming the adhesive layer 2, 30 μl of the adhesive to be the adhesive layer 2 was discharged on the base material 1 using a precision dispenser. Next, the resin film to be the resin layer 3 was brought into contact with the adhesive from the top, and a flat plate glass for pressurization weighing 3 kg was put on the top and allowed to rest for 120 seconds. In the step of forming the adhesive layer 4, 33 μl of the adhesive to be the adhesive layer 4 was discharged on the surface of the first intermediate element on the side of the resin film using the precision dispenser. Next, the base material 5 was brought into contact with the adhesive from the top, and a parallel plate glass for pressurization weighing 3 kg was placed on the top and allowed to rest for 110 seconds. The optical element 10 according to Example 9 was manufactured in the same manner as in Example 7 except for these points.

The optical element 10 according to Example 9 was evaluated as “B” since the reflected wavefront change was 190 nm when the reflected wavefront change with respect to the environmental temperature change was measured in the same manner as in Example 1.

The average thickness of the adhesive layer 2 and the adhesive layer 4 was measured in the optical element 10 according to Example 9 in the same manner as in Example 1. As a result, the average thickness of the adhesive layer 2 was 9 μm and the average thickness of the adhesive layer 4 was 10 μm in the optical element 10 according to Example 9.

### Comparative Example 1

In Comparative Example 1, in the step of forming the adhesive layer 7, 20 μl of the adhesive to be the adhesive layer 7 was discharged on the surface of the second intermediate element on the side of the resin film using the precision dispenser. Next, the base material 5 was brought into contact with the adhesive from the top, and a plate glass for pressurization weighing 3 kg was placed on the top and allowed to rest for 180 seconds. The optical element 10 according to Comparative Example 1 was manufactured in the same manner as in Example 2 except for these points.

When the reflected wavefront change with respect to the environmental temperature change was measured for the optical element 10 according to Comparative Example 1 in the same manner as in Example 1, the optical element 10 according to Comparative Example 1 was evaluated as “C” since the reflected wavefront change was 220 nm.

Also, for the optical element 10 according to Comparative Example 1, the average thicknesses of the adhesive layer 2, the adhesive layer 4, and the adhesive layer 7 were measured in the same manner as in Example 1. As a result, in the optical element 10 according to Comparative Example 1, the average thickness of the adhesive layer 2 was 6 μm, the average thickness of the adhesive layer 4 was 6 μm, and the average thickness of the adhesive layer 7 was 6 μm.

### Comparative Example 2

In Comparative Example 2, the optical element 10 was manufactured without forming the resin layer 6 and the adhesive layer 7. In the step of forming the adhesive layer 2, 20 μl of the adhesive to be the adhesive layer 2 was discharged on the base material 1 using the precision dispenser. Next, the resin film to be the resin layer 3 was brought into contact with the adhesive from the top, and a plate glass for pressurization weighing 3 kg was placed on the top and allowed to rest for 180 seconds. In the step of forming the adhesive layer 4, 20 μl of the adhesive to be the adhesive layer 4 was discharged on the surface of the first intermediate element on the side of the resin film using the precision dispenser. Next, the base material 5 was brought into contact with the adhesive from the top, and a plate glass for pressurization weighing 3 kg was placed on the top and allowed to rest for 180 seconds. The optical element 10 according to Comparative Example 2 was manufactured in the same manner as in Example 2 except for these points.

The optical element 10 according to Comparative Example 2 was evaluated as “C” since the reflected wavefront change was 240 nm when the reflected wavefront change with respect to the environmental temperature change was measured in the same manner as in Example 1.

In the optical element 10 according to Comparative Example 2, the average thickness of the adhesive layer 2 and the adhesive layer 4 was measured in the same manner as in Example 1. As a result, in the optical element 10 according to Comparative Example 2, the average thickness of the adhesive layer 2 was 6 μm and the average thickness of the adhesive layer 4 was 6 μm.

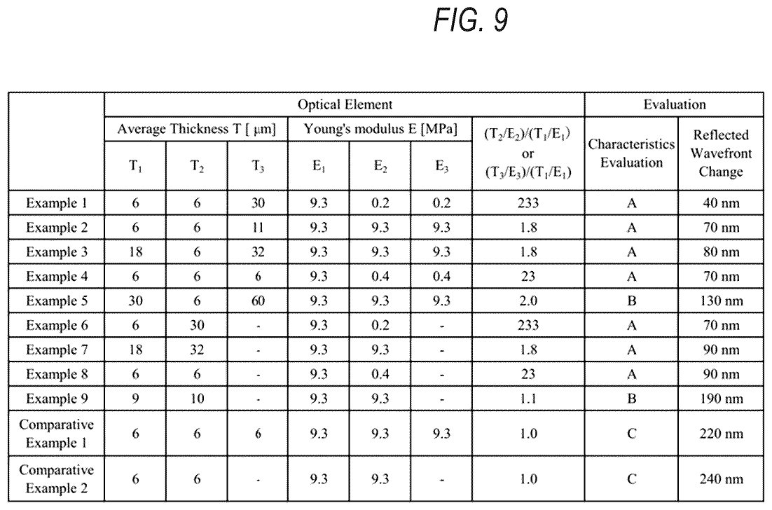

The evaluation results for Examples 1 to 9 and Comparative Examples 1 and 2 are shown in FIG. 9, together with various numerical values. Values of (T3/E3)/(T1/E1) are shown for Examples 1 to 5, while values of (T2/E2)/(T1/E1) are shown for Examples 6 to 9 and Comparative Example 2. Values of (T2/E2)/(T1/E1) and (T3/E3)/(T1/E1), which are equal to each other, are shown for Comparative Example 1.

As shown in FIG. 9, the optical elements 10 according to Examples 1 to 9 reduce the change of the reflected wavefront when the environmental temperature changed, and thus reduce or prevent the deterioration of the optical characteristics.

### Second Embodiment

The optical element 10 according to the first embodiment can be applied to various equipment, apparatuses, and the like such as optical equipment, display apparatuses, imaging apparatuses, and the like. In the second embodiment, optical equipment will be described as applications of the optical element 10 according to the first embodiment.

### (Optical Equipment)

Specific applications of the optical element 10 according to the first embodiment include lenses that constituting optical equipment (display optical system) for head-mounted displays and liquid crystal projectors, lenses constituting optical equipment (imaging optical system) for cameras and video cameras, and the like. Each of these optical systems includes at least one optical element arranged in a housing, and the optical element 10 according to the first embodiment can be used for at least one of the optical elements.

### (Display Apparatus)

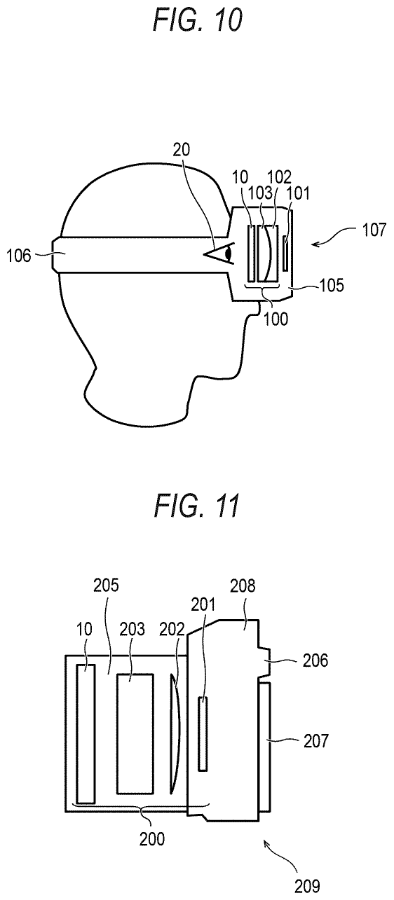

FIG. 10 is a schematic cross-sectional view illustrating a configuration of a head-mounted display 107, which is an example of an embodiment of a display apparatus using the optical element 10 according to the first embodiment.

As illustrated in FIG. 10, the head-mounted display 107 includes a housing 105, a mounting tool 106, a display optical system 100 for each of the left eye and the right eye, and a display panel 101 for each of the left eye and the right eye. Each display optical system 100 and each display panel 101 are provided in the housing 105. The head-mounted display 107 is configured to mount on the head of a user by the mounting tool 106 so that the display optical systems 100 for the left eye and the display panels 101 for the right eye are positioned corresponding to the left eye and the right eye of the user, respectively.

Each display optical system 100 is arranged relative to the corresponding display panel 101 and includes an optical element 102, an optical element 103, and the optical element 10 according to the first embodiment. The display panel 101 is a display unit of an organic electroluminescence panel, a liquid crystal panel, or the like, and displays a corresponding image for the left eye or the right eye. The optical element 102, the optical element 103, and the optical element 10 in the display optical system 100 are elements that form an image light emitted from the display panel 101 positioned with the eye 20 of the user. As described above with reference to FIG. 5, the display optical system 100 is a folding optical system in which an optical path is folded back by an optical functional surface such as a reflective polarizing layer, a phase difference layer, a transmissive-reflective layer, and the like in the display optical system 100. Depending on the design of the head-mounted display 107, the display optical system 100 may include a transmission optical element such as a convex lens or a concave lens, an optical path-changing optical element such as a polarization beam splitter (PBS), a half mirror, a polarizing plate, or a phase difference plate, or the like. The optical element 10, together with the optical element 102 and the optical element 103, constitutes an optical system for guiding image light, which is light emitted from the display panel 101, to the eye 20 of the user, and functions as at least one of the optical elements in the optical system.

The display apparatus has been described using a head-mounted display here, but the optical element 10 can also be used in the same way for a projector or the like.

### (Imaging Apparatus)

FIG. 11 is a schematic diagram illustrating a configuration of a digital camera 209, which is an example of an embodiment of an imaging apparatus using the optical element 10 according to the first embodiment. In FIG. 11, the camera main body 208 is coupled to the lens barrel 205 which is optical equipment, and the lens barrel 205 may be a so-called interchangeable lens detachable from the camera main body 208 or fixed to the camera main body 208.

Light from an object is imaged and captured on an image sensor 201 which is an imaging element through an imaging optical system 200 including a plurality of optical elements arranged on the optical axis in the housing of the lens barrel 205. The image captured by the image sensor 201 is stored in a memory in the camera main body 208 and is displayed on an electronic viewfinder 206 or a monitor 207 so that a user can check the image. Each optical element is movably supported on the outer barrel of the lens barrel 205 for focusing and zooming. As described above with reference to FIG. 6, the imaging optical system 200 is a folding optical system in which an optical path is folded back by an optical functional surface such as a reflective polarizing layer, a phase difference layer, and a transmissive-reflective layer in the imaging optical system 200. The optical element 10, together with the optical element 202 and the optical element 203, constitutes an optical system for guiding light from a subject to the image sensor 201, and functions as at least one of the optical elements in the optical system.

According to the present disclosure, in an optical element in which a resin layer is integrated between two base materials via an adhesive layer, deterioration of optical characteristics due to a temperature difference can be reduced or prevented.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-113388, filed Jul. 16, 2024, the entirety of which is incorporated herein by reference.

What is claimed is:

1. An optical element comprising:
a first base material;
a first adhesive layer;
a resin layer having a reflection characteristic;
a second adhesive layer; and
a second base material,
wherein the first base material, the first adhesive layer, the resin layer, the second adhesive layer, and the second base material are laminated in this order, and
wherein:
$$1.1 \times T 1 / E 1 \leq T 2 / E 2 ,$$
with T1 being an average thickness of the first adhesive layer, E1 being a Young's modulus of the first adhesive layer, T2 being an average thickness of the second adhesive layer, and E2 being a Young's modulus of the second adhesive layer.

2. The optical element according to claim 1, wherein:
$$1.8 \times T 1 / E 1 \leq T 2 / E 2.$$

3. The optical element according to claim 1, wherein the resin layer is configured as a reflective polarizing layer.

4. The optical element according to claim 1, wherein T1 is 20 μm or less.

5. The optical element according to claim 1, wherein the first base material and the second base material have different linear expansion coefficients from each other.

6. The optical element according to claim 1, wherein the first base material and the second base material each include glass materials.

7. The optical element according to claim 1, wherein at least one of the first base material and the second base material is configured to function as a lens.

8. An optical system arranged between a sensor into which light from an object is incident and the object,
wherein the optical system includes the optical element according to claim 1, and
wherein the optical element is configured to reflect the light before the light reaches the sensor.

9. Optical equipment comprising:
a housing; and
an optical system including at least one optical element arranged in the housing,
wherein the at least one optical element is the optical element according to claim 1.

10. A display apparatus comprising:
a housing;
an optical system including at least one optical element arranged in the housing; and
a display unit configured to emit light guided by the optical system,
wherein the at least one optical element is the optical element according to claim 1.

11. An imaging apparatus comprising:
a housing; an optical system including at least one optical element arranged in the housing; and
an imaging element configured to receive light passing through the optical system,
wherein the at least one optical element is the optical element according to claim 1.

12. An optical element comprising:
a first base material;
a first adhesive layer;
a first resin layer having a reflection characteristic;
a second adhesive layer;
a second resin layer;
a third adhesive layer; and
a second base material,
wherein the first base material, the first adhesive layer, the first resin layer, the second adhesive layer, the second resin layer, the third adhesive layer, and the second base material are laminated in this order, and
wherein:
$$1.1 \times T 1 / E 1 \leq T 2 / E 2 , or$$
$$1.1 \times T 1 / E 1 \leq T 3 / E 3 ,$$
with T1 being an average thickness of the first adhesive layer, E1 being a Young's modulus of the first adhesive layer, T2 being an average thickness of the second adhesive layer, E2 being a Young's modulus of the second adhesive layer, T3 being an average thickness of the third adhesive layer, and E3 being a Young's modulus of the third adhesive layer.

13. The optical element according to claim 12, wherein:
$$1.8 \times T 1 / E 1 \leq T 2 / E 2 , or$$
$$1.8 \times T 1 / E 1 \leq T 3 / E 3.$$

14. The optical element according to claim 12,
wherein the first resin layer is configured as a reflective polarizing layer, and
wherein the second resin layer is configured as a phase difference layer.

15. The optical element according to claim 12, wherein T1 is 20 μm or less.

16. The optical element according to claim 12, wherein the first base material and the second base material have different linear expansion coefficients from each other.

17. An optical system arranged between a sensor into which light from an object is incident and the object,
wherein the optical system includes the optical element according to claim 12, and
wherein the optical element is configured to reflect the light before the light reaches the sensor.

18. Optical equipment comprising:
a housing; and
an optical system including at least one optical element arranged in the housing,
wherein the at least one optical element is the optical element according to claim 12.

19. A display apparatus comprising
a housing; an optical system including at least one optical element arranged in the housing; and
a display unit configured to emit light guided by the optical system,
wherein the at least one optical element is the optical element according to claim 12.

20. An imaging apparatus comprising:
a housing;
an optical system including at least one optical element arranged in the housing; and
an imaging element configured to receive light passing through the optical system,
wherein the at least one optical element is the optical element according to claim 12.
